(19) United States
(12) Patent Application Publication
(10) Pub. No.: US 2012/0171606 A1
(43) Pub. Date: Jul. 5, 2012

(54) BIMODAL STYRENE VINYL POLYMER LATEX FOR CHEMICALLY PRODUCED TONER

(75) Inventors: Francis L. CHUPKA, Columbia, TN (US); Akira MISAWA, Boston, MA (US)

(73) Assignee: IMAGE POLYMERS COMPANY, LLC, Andover, MA (US)

(21) Appl. No.: 13/206,894

(22) Filed: Aug. 10, 2011

Related U.S. Application Data
(60) Provisional application No. 61/428,508, filed on Dec. 30, 2010.

(51) Int. Cl. C08F 2/22; G03G 9/16

(52) U.S. Cl. 430/113; 430/137.17

(57) ABSTRACT

A process is provided for preparing a bimodal styrene vinyl polymer latex composition, which may be used to prepare toner for use in electrophotographic applications by the emulsion aggregation process. The process includes preparing a low molecular weight styrene polymer (LMWP) by solution polymerization, preparing a solution of the LMWP in a mixture of styrene and vinyl monomers, emulsifying the LMWP/monomer solution in water, and polymerizing the LMWP and mixture of styrene and vinyl monomers via emulsion polymerization to yield a bimodal molecular weight composition. The latex affords excellent fixing when used in chemically produced toners such as toners produced by emulsion aggregation.

### CROSS-REFERENCE TO RELATED APPLICATION

This application claims the benefit of U.S. provisional patent application No. 61/428,508, filed Dec. 30, 2010.

### BACKGROUND OF THE INVENTION

The present invention relates to a bimodal styrene vinyl polymer latex, such as a styrene acrylate polymer latex, that may be used as the binder in chemically produced toner made by the emulsion aggregation process for use in electrophotography.

Two key types of processes are used to produce electrophotographic toners. Conventional routes are mechanical grinding processes, which yield mechanically pulverized toner (MPT). More recently, methods for producing chemically produced (or prepared) toner (CPT) have been developed. CPTs have been shown to offer significant benefits, including smaller particle size (better resolution), lower energy use, better control over particle shape, and narrower particle size distribution.

There are several methods to produce CPT, including suspension polymerization, emulsion aggregation (EA), dispersion polymerization, and chemical milling.

Styrene acrylate polymers are particularly suited for an EA-CPT process because these latexes can be made directly from monomers by emulsion polymerization. A disadvantage is that emulsion polymerization of vinylic monomers (e.g., styrene and alkyl (meth)acrylates) yields high molecular weight polymers which are detrimental to good low temperature fixing. To improve fixing, high concentrations of low melting point waxes are added to the toner formulation. However, the use of high wax levels can lead to coating of toner material on the printer or copier parts (i.e., developing and fusing rollers) during the printing process.

Polyester latexes have also been used to prepare EA-CPT. However, polyester latexes cannot be polymerized directly by emulsion polymerization. Instead, a solution of the polyester resin in a low boiling point solvent is emulsified in water, and the solvent is subsequently removed by distillation to yield the polyester emulsion.

From experience with MPTs made by conventional manufacturing processes, it is known that bimodal styrene acrylate resins which contain a low molecular weight component have good low temperature fixing properties. These resins are typically produced by solution polymerization, which is much preferred over emulsion polymerization for producing low molecular weight polymers. Polymers with number average molecular weights less than 5,000 Daltons can be produced by solution polymerization, whereas these low molecular weights cannot be achieved using emulsion polymerization. Under atmospheric conditions using aromatic solvent in a batch solution polymerization process, high concentrations of free radical initiator are required to attain these low molecular weights. However, under pressure and high temperature, these low molecular weight polymers can be produced using low concentrations of initiator. The solution polymerization process can be conducted batch-wise or continuously, as described in U.S. Pat. No. 4,963,456.

It would be desirable to develop a bimodal styrene vinyl latex which could circumvent the disadvantages with fixing monomodal styrene vinyl latexes and the need for using solvents to produce polyester latexes.

### BRIEF SUMMARY OF THE INVENTION

The present invention provides a process for producing a bimodal molecular weight styrene vinyl latex polymer composition comprising:
(a) preparing a low molecular weight styrene polymer by solution polymerization of at least one styrene monomer;
(b) preparing a solution of the low molecular weight styrene polymer in a mixture containing styrene and at least one vinyl monomer;
(c) emulsifying the solution in water to form an emulsion; and
(d) polymerizing the low molecular weight styrene polymer and mixture containing styrene and at least one vinyl monomer using emulsion polymerization to form a bimodal molecular weight latex composition.

A bimodal molecular weight styrene vinyl latex polymer composition prepared by a process comprising:
(a) preparing a low molecular weight styrene polymer by solution polymerization of at least one styrene monomer;
(b) preparing a solution of the low molecular weight styrene polymer in a mixture containing styrene and at least one vinyl monomer;
(c) emulsifying the solution in water to form an emulsion; and
(d) polymerizing the low molecular weight styrene polymer and mixture containing styrene and at least one vinyl monomer using emulsion polymerization to form a bimodal molecular weight latex composition.

A process for producing a chemically produced toner by emulsion aggregation comprises emulsion polymerizing a bimodal styrene vinyl latex polymer composition prepared by a process comprising:
(a) preparing a low molecular weight styrene polymer by solution polymerization of at least one styrene monomer;
(b) preparing a solution of the low molecular weight styrene polymer in a mixture containing styrene and at least one vinyl monomer;
(c) emulsifying the solution in water to form an emulsion; and
(d) polymerizing the low molecular weight styrene polymer and mixture containing styrene and at least one vinyl monomer using emulsion polymerization to form a bimodal molecular weight latex composition.

### DETAILED DESCRIPTION OF THE INVENTION

The present invention relates to a process for preparing a bimodal styrene vinyl polymer latex composition, such as a styrene acrylate polymer latex composition. Such a polymer latex may be used in the production of photoelectrographic toner by an EA-CPT process. As described in more detail below, the process involves first preparing a low molecular weight styrene polymer or styrene vinyl copolymer (LMWP) by solution polymerization, followed by preparing a solution of the LMWP in styrene and vinyl monomers. Subsequently, the method involves emulsifying the solution into water and polymerizing the emulsion by emulsion polymerization. The resulting bimodal styrene vinyl polymer latex has distinct low and high molecular weight components. The low molecular weight polymer, made by solution polymerization, acts as a fixing additive to improve low temperature fixing when the latex is used in a toner, whereas the high molecular weight portion of the composition is formed from emulsion polymerization of the styrene and vinyl monomers.

### Preparation of the LMWP

The first step of the process for producing the latex according to the invention involves preparing a low molecular weight styrene polymer or styrene vinyl copolymer by solution polymerization of styrene and optionally vinyl monomers. The low molecular weight styrene polymer component is important for achieving good fixing when the polymer latex is used in a toner. Solution polymerization is preferably performed in aromatic solvent (such as xylene) under high temperature and pressure via a continuous process. However, it is also within the scope of the invention to produce the LMWP using a batch process under atmospheric pressure, which limits the reaction temperature and thus requires high initiator concentrations to achieve the desired low molecular weight. As described in more detail below, the LMWP is preferably obtained by continually feeding styrene and optionally vinyl monomers, a polymerization initiator, and solvent into a system maintained at about 190-230° C.

The styrene polymer is formed from polymerization of styrene or from mixtures of styrenic and vinylic monomers in which the major component is styrene. Preferred vinyl monomers include, without limitation, o-methylstyrene, m-methylstyrene, p-methylstyrene, a-methylstyrene, p-t-butylstyrene, vinylnaphthalene, vinyl chloride, vinyl fluoride, vinyl acetate, acrylonitrile, methacrylonitrile, acrylamide, methacrylamide, acrylic acid, methacrylic acid, fumaric acid, maleic acid, maleic anhydride, itaconic acid, cinnamic acid, crotonic acid, methyl acrylate, ethyl acrylate, n-propyl acrylate, i-propyl acrylate, n-butyl acrylate, i-butyl acrylate, cyclohexyl acrylate, 2-ethylhexyl acrylate, stearyl acrylate, methyl methacrylate, ethyl methacrylate, n-propyl ethacrylate, i-propyl methacrylate, n-butyl methacrylate, 2-ethylhexyl methacrylate, stearyl methacrylate, dimethyl fumarate, diethyl fumarate, di-i-propyl fumarate, di-n-butyl fumarate, di-i-butyl fumarate, dimethyl maleate, diethyl maleate, di-i-propyl maleate, di-n-butyl maleate, di-i-butyl maleate, 2-vinylpyridine, 2-vinylpyrole, N-vinylcarbazole, N-vinylindole and N-vinylpyrrolidone. Most preferred vinyl monomers include alkylacrylates, alkyl methacrylates, methacrylic acid, and acrylic acid.

For continuous polymerization, the initiator is preferably used in an amount of about 0.05 to 5 parts by weight per 100 parts by weight of the styrene/vinyl monomers. When the LMWP is produced using batch polymerization at atmospheric pressure, about 10 parts by weight initiator per 100 parts by weight of the monomers are required to obtain a molecular weight of less than 5,000 Daltons.

The solution polymerization initiator is preferably an oil soluble radical polymerization initiator which is known in the art or to be developed, such as perester, hydroperoxide, dialkyl peroxide, ketone peroxide, diacyl peroxide, percarbonate, azobis derivatives, etc. Exemplary initiators include, for example, t-butyl peroctoate, t-butyl perbenzoate, t-butyl perisobutyrate, t-butyl hydroperoxide, cumene hydroperoxide, di-t-butyl peroxide, t-butyl cumyl peroxide, dicumyl peroxide, methyl ethyl ketone peroxide, methyl isobutyl ketone peroxide, cyclohexanone peroxide, acetyl peroxide, lauryl peroxide, benzoyl peroxide, diisopropyl peroxydicarbonate, bis(4-t-butyl cyclohexyl) peroxydicarbonate, 2,2′-azobisisobutyronitrile, 2-phenylazo-2,4-dimethyl-4-methoxyvaleronitrile and 2,2′-azobis(2-methylpropane). The dialkyl peroxide polymerization initiators such as di-t-butyl peroxide, t-butyl cumyl peroxide and dicumyl peroxide are particularly preferred for use among these initiators.

Appropriate solvents for the solution polymerization are compounds having sufficient solubility for the styrene and vinyl monomers and the corresponding polymers. Preferred solvents include, for example, aliphatic hydrocarbons, aromatic hydrocarbons, esters, ethers, ketones, alcohols, cellosolves, carbitols, formamides, and sulfamides. These solvents may be used singularly or in combination. Particularly preferred solvents are aromatic solvents, including xylene, ethylbenzene, benzene, toluene. ethyl acetate and SOLVESSO™ #100 and #150 (products of Exxon Petroleum Co.).

The temperature for polymerizing the styrene and optionally vinyl monomers by continuous polymerization is preferably about 190° C.-230° C., more preferably about 200°-220° C. A polymerization temperature less than about 190° C. is undesirable because a low molecular weight polymer cannot be obtained and the fixing ability of the resulting toner deteriorates. Polymerization temperatures exceeding about 230° C. are also undesirable because a relatively large amount of oligomer, which is believed to be the thermal reaction product of the monomer, is generated as a by-product, thus reducing the blocking resistance of the resulting toner. Continuous polymerization may be conducted at a pressure of about 3.3-6.8 kg/cm², more preferably at a pressure of about 6 kg/cm². In contrast, batch polymerization is preferably performed at atmospheric pressure at a temperature of about 130° C. (the reflux temperature of the solvent). However, batch polymerization is inherently more dangerous due to the high concentration of radical initiator required to achieve the desired low molecular weight, and thus continuous polymerization is preferred.

The styrene polymer obtained by polymerizing the styrene and vinyl monomers contains styrene as the major component. Preferred styrene copolymers further contain as comonomers alkyl acrylates and alkyl methacrylates, such as those having about one to eight carbon atoms, preferably about four carbon atoms, and acidic vinyl comonomers, such as acrylic acid, methacrylic acid, and β-carboxyethylacrylate. Exemplary low molecular weight polymers contain 100% styrene; 93.5% styrene and 6.5% n-butyl acrylate; and 93% styrene, 6% n-butyl acrylate, and 1% methacrylic acid.

The number average molecular weight (Mn) of the styrene polymer is preferably about 1,000 to 10,000 Daltons, more preferably about 2,000 to 5,000 Daltons, most preferably about 1,500 to 2,800 Daltons. A Mn less than about 1,000 Daltons is undesirable because the blocking resistance of the toner decreases. On the other hand, a Mn of more than about 5,000 Daltons is also undesirable because the fixing ability of the resulting toner deteriorates. The low molecular weight styrene polymer preferably has a weight average molecular weight (Mw) of about 1,000 to 12,000 Daltons.

The glass transition temperature of the styrene polymer is preferably about 40° to 75° C., more preferably about 50° to 70° C., most preferably about 55° to 65° C. A glass transition temperature of less than about 40° C. is undesirable because the blocking resistance of the resulting toner decreases. Conversely, a glass transition temperature greater than about 75° C. is also undesirable because the fixing ability of the toner deteriorates.

Following polymerization, the styrene polymer is isolated from the reaction mixture by removing the solvent, preferably in a two stage distillation process. The first step is preferably conducted under a nitrogen sparge to a pot temperature of about 190° C., at which time the contents are subjected to a vacuum of about 0.5 to 5 mm Hg (stage 2) at about 190°-200° C. for about 1.5 hours.

### Preparation of Low Molecular Weight Polymer/Monomer Solution:

The second step of the process of the invention involves preparing a solution of the LMWP by dissolving the isolated LMWP in a mixture of vinylic monomers containing styrene and at least one vinyl monomer. Exemplary monomers include, but are not limited to, alkyl acrylates, such as methyl acrylate, ethyl acrylate, butyl acrylate, isobutyl acrylate, dodecyl acrylate, n-octyl acrylate, 2-ethylhexyl acryl ate, 2-chloroethyl acrylate, phenyl acrylate, β-carboxyethyl acrylate, methyl α-chloro acrylate, methyl methacrylate, ethyl methacrylate, and butyl methacrylate; butadiene, isoprene. methacrylonitrile, acrylonitrile; vinyl ethers, such as methyl vinyl ether, vinyl isobutyl ether, and vinyl ethyl ether; vinyl esters, such as vinyl acetate, vinyl propionate, vinyl benzoate, and vinyl butyrate; vinyl ketones, such as vinyl methyl ketone, vinyl hexyl ketone, and methyl isopropenyl ketone; vinylidene halides, such as vinylidene chloride and vinylidene chloro fluoride. N-vinylindole, pyrrolidene, acrylic acid, methacrylic acid, acrylamide, methacrylamide, vinyl pyridine, vinyl pyrrolidone, vinyl N-methylpyridinium chloride, vinyl naphthalene, p-chlorostyrene, vinyl chloride, vinyl fluoride, ethylene, propylene, butylene, isobutylene and the like.

A preferred mixture contains predominantly styrene with an alkyl acrylate or alkyl methacrylate (containing about one to about eight carbon atoms, preferably about four carbon atoms) as a minor component, and optionally also contains a vinyl acid monomer, such as acrylic or methacrylic acid. An exemplary mixture of monomers contains about 60-80% styrene, about 20-40% n-butyl acrylate, and about 2.5-3% methacrylic acid. The monomer mixture will subsequently form the high molecular weight portion of the bimodal polymer upon emulsion polymerization. Accordingly, preferred high molecular weight emulsion polymers are styrene copolymers, such as copolymers with alkyl acrylates or alkyl methacrylates, or acidic vinyl monomers (acrylic acid, methacrylic acid, and β-carboxyethylacrylate).

In order to be effective as a toner resin, the resin must have a glass transition temperature in an acceptable range, such as a Tg of about 45 to 65° C. Styrene homopolymer has a Tg of 100° C. (373K), and the Tg of styrene copolymers varies based on the comonomer used. The following equation may be used to estimate the Tg (in K) of a styrene copolymer when the molecular weight of the copolymer exceeds 10,000-15,000 Daltons. The Tg of polymers with molecular weights less than 10,000-15,000 Daltons (such as the LMWP) is dependent upon the molecular weight.

1/Tg=wt % M₁/Tg₁+wt % M₂/Tg₂+

In this equation, Mₓ represents a vinyl monomer, M₁ is typically styrene, and Tgₓ represents the Tg of the homopolymer of the vinyl monomer. The homopolymer of n-butyl acrylate has a Tg of −56° C. (217K), and thus a ratio of 80:20 styrene:n-butyl acrylate will produce a copolymer having a Tg in the desired range, whereas n-butyl methacrylate homopolymer (Tg=20° C. (293K)) will require a 65-70:30-35 styrene:n-butyl methacrylate ratio to achieve the desired Tg of the copolymer.

It is within the scope of the invention to add branching agents to the monomer mixture to control the branching structure of the bimodal polymer. Exemplary branching agents include multifunctional vinyl compounds, such as divinylbenzene, alkyl diacrylates, alkyl dimethacrylates, and multifunctional monomers of similar composition, such as trimethylpropane triacrylate and pentaerythritol acrylate. These agents may be added at a concentration of about 0 to 2% based on monomers, preferably about 0.1 to 0.5%.

Chain modifiers (also known as chain transfer agents) to control molecular weight during the emulsion polymerization step and thus the polymerization degree, molecular weight, and molecular weight distribution of the product latex may also be included. Preferred chain transfer agents are thiols. Exemplary chain transfer agents include, but are not limited to, mercaptans, including n-C₃₋₁₅ alkylmercaptans, such as n-propylmercaptan, n-butylmercaptan, n-amylmercaptan, n-hexylmercaptan, n-heptylmercaptan, n-octylmercaptan, n-nonylmercaptan, n-decylmercaptan, and n-dodecylmercaptan; branched alkylmercaptans, such as isopropylmercaptan, isobutylmercaptan, s-butylmercaptan, tert-butylmercaptan, cyclohexylmercaptan, tert-hexadecylmercaptan, tert-laurylmercaptan, tert-nonylmercaptan, tert-octylmercaptan, and tert-tetradecylmercaptan; and aromatic ring-containing mercaptans, such as allylmercaptan, 3-phenylpropylmercaptan, phenylmercaptan and mercaptotriphenylmethane.

Typical examples of appropriate chain transfer agents also include, but are not limited to alkylthioglycolates, dodecanethiol, butanethiol, isooctyl-3-mercaptopropionate, 2-methyl-5-t-butyl-thiophenol, carbon tetrachloride, carbon tetrabromide and the like. Based on the total weight of the monomers to be polymerized, the chain transfer agent is preferably present in an amount of about 0.01% to 2%, preferably about 0.01 to 0.5%.

It is also within the scope of the invention to include cross linked structures cross-linked by cross-linking agents with two or more vinyl groups. Exemplary cross-linking agents include aromatic divinyl compounds, such as divinyl benzene and divinyl naphthalene. Examples of diacrylate compounds bonded by alkyl chains include ethylene glycol diacrylate, 1,3-butylene glycol diacrylate, 1,4-butane diol diacrylate, 1,5-pentane diol diacrylate, 1,6-hexane diol diacrylate, neopentyl glycol diacrylate, diethylene glycol diacrylate, triethylene glycol diacrylate, tetraethylene glycol diacrylate, polyethylene 400 glycol diacrylate, polyethylene 600 glycol diacrylate, dipropylene glycol diacrylate, and compounds where the acrylate is replaced by methacrylate. Examples of diacrylate compounds bonded by aromatic-containing chains include polyoxyethylene(2)-2,2-bis(4-hydroxyphenyl) propane diacrylate, polyoxyethylene(4)-2,2-bis(4-hydroxyphenyl) propane diacrylate and a compound in which diacrylate is replaced by dimethacrylates.

If included, the cross-linking agent may be included in an amount of about 0.05 to 1.0% based on the total weight of the monomers to be polymerized. The level of crosslinking or gel should be sufficient to impart toughness and provide hot offset resistance to the subsequent toner product while maintaining the thermoplastic character of the polymer and its ability to melt.

The low molecular weight polymer is completely soluble in the styrene and vinyl monomer mixture and can be dissolved at room temperature with gentle stirring. The concentration of LMWP in monomers is preferably about 1 to about 50%, more preferably about 20 to about 50%, most preferably about 20 to about 30%.

### Emulsion of Monomer/Low Molecular Weight Polymer Solution

After preparing the monomer/LMWP solution, the solution is emulsified into deionized water using typically available surfactants or combinations thereof and an appropriate high shear disperser. For example, appropriate high shear dispersing apparatuses include blenders, bead mixers, ultrasonic dispersers, and high pressure type dispersers; blenders and high pressure type dispersers are preferred, such as an IKA Labotechnik T-45 rotor-stator disperser fitted with a TP45P generator.

Preferably, a solution of water soluble surfactant in deionized water is prepared, and the LMWP/monomer solution is emulsified into the surfactant solution using the disperser. It may be desirable to perform dispersing at increasing speeds, such as about 5,000 rpm for about 5 minutes and then at about 10,000 rpm for about 10 minutes. A preferred ratio of solution (organic or oil phase) to aqueous phase is about 1:4 (20% oil phase) to 3:2 (60% oil phase), more preferably about 1:1 (50% oil phase). In a preferred embodiment, equal weights of water and LMWP/monomer solution are combined with about 2-6% surfactant based on water. Subsequently, the emulsion is preferably degassed and sparged with an inert gas, such as nitrogen.

Suitable surfactants can be of the anionic, non-ionic, or cationic type or mixtures thereof, but preferred surfactants are anionic and non-ionic types or combinations thereof.

Examples of suitable anionic surfactants include, but are not limited to, sodium alkyl sulfates and sodium alkyl sulfonates (such as those having about 12 to 16 carbon atoms), including sodium dodecyl sulfate, sodium dodecylbenzene sulfonate, sodium dodecylnaphthalene sulfate, dialkylbenzenealkyl sulfates and sulfonates, sodium ethoxylated esters, Calsoft® (available from Pilot Chemical Co.), Dowfax® (available from Dow Chemical Co.), Neogen R and SC® (available from Kao), TaycaPower® (available from Tayca Corp.), ethoxylated phosphate ester salts, and Dextrol® (available from Ashland Chemical Co.), as well as mixtures thereof. Anionic surfactants may be employed at any effective amount, generally at least about 0.5% based on total monomer and polymer weight and generally no more than about 10% based on the total monomer and polymer weight. Preferred amounts are about 1% to 6% based on monomer and polymer weight depending on the ratio of LMWP to monomers in the organic phase, or about 2 to 6% based on water.

Examples of suitable nonionic surfactants include, but are not limited to, polyvinyl alcohol, polyacrylic acid, methyl cellulose, ethyl cellulose, hydroxyethyl cellulose, carboxyethyl cellulose, polyoxyethylene cetyl ether, polyoxyethylene lauryl ether, polyoxyethylene octyl ether, polyethylene sorbitan monolaurate, polyoxyethylene stearyl ether, polyoxyethylene nonylphenyl ether, dialkylphenoxypoly(ethylene oxy) ethanol (available from Rhone Poulenc as Igepal® and Antranox®) and Surfonic® L24-22 and L68-20 (available from Huntsman Chemical Co.). as well as mixtures thereof.

Examples of suitable cationic surfactants include, for example, dialkylbenzenealkyl ammonium chloride, lauryl trimethyl ammonium chloride, alkyl benzyl methyl ammonium chloride, alkyl benzyl dimethyl ammonium chloride, alkyl benzyl dimethyl ammonium bromide, cetyl pyridinium bromide, C_{12-C17} trimethyl ammonium bromide, halide salts of quaternized polyoxyethylalkyl amines, dodecylbenzyl trimethyl ammonium chloride, Mirapol® and Alkaquat® (available from Alkaril Chemical Co.), Sanazol® (available from Kao Corp.), as well as combinations thereof.

### Emulsion Polymerization

Finally, the low molecular weight polymer and vinyl monomers are polymerized by emulsion polymerization, which may be performed using any suitable process with a free radical initiator at elevated temperature. However, a semi continuous process (seed emulsion polymerization) is preferred to a batch process in order to minimize batch-to-batch variation and to obtain more consistent molecular weight and particle size.

The polymerization reactor utilized preferably includes means for stirring, heat control, emulsion addition, and inert gas sparging. The typical mixing rate for a 1 liter reactor is about 150 to 220 rpm, preferably about 190 to 200 rpm.

The seed polymerization process involves first preparing an initiator solution in deionized water. A polymerization reactor is charged with an aqueous surfactant solution and the temperature is elevated to about 65 to 95° C. with stirring under a nitrogen atmosphere. The surfactant solution may be identical to or different than that used to form the monomer/LMWP emulsion; preferred surfactants are described above. The amount of surfactant solution charged to the reactor is calculated to afford the desired final solids content in the latex. Typical solids contents of about 20 to 60%, such as about 30 to 35%, are preferred.

Subsequently, the process involves adding a portion (typically about 3-10%) of the

LMWP/monomer emulsion to the surfactant solution, then adding the initiator solution and allowing it to polymerize and form the seed polymer. The contents are heated to the desired polymerization temperature, preferably about 50-90° C., depending on the initiator used. Typically a temperature of about 70-75° C. is employed.

To complete the emulsion polymerization, the remainder of the monomer/LMWP emulsion is added over an extended time period (such as about 2 to 6 hours), followed by a post polymerization period of about two hours conducted at the polymerization temperature to complete the conversion of monomers.

Any suitable initiator or mixture of initiators may be utilized in the emulsion polymerization according to the invention. Preferably, the initiator is selected from various known free radical polymerization initiators. The free radical initiator can be any free radical polymerization initiator capable of initiating a free radical polymerization process or mixtures thereof, typically free radical initiators capable of providing free radical species upon heating to above about 30° C. Appropriate initiators include both water soluble free radical initiators that are traditionally used in emulsion polymerization reactions, as well as oil soluble free radical initiators.

Examples of suitable free radical initiators include, but are not limited to, peroxides, such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzyl peroxide, lauroyl peroxide, diisopropyl peroxycarbonate, tetralin hydroperoxide, 1-phenyl-2-methylpropyl-1-hydro-peroxide, tert-butyihydroperoxide, ammonium persulfate, sodium persulfate, potassium persulfate, pertriphenylacetate, tert-butyl performate, tert-butyl peracetate, tert-butyl permethoxyacetate, and tert-butylper-N-(3-toluyl) carbamate; azo compounds such as 2,2′-azobispropane, 2,2′-dichloro-2,2′-azobispropane, 1,1′-azo(methylethyl) diacetate, 2,2′-azobis(2-amidinopropane) hydrochloride, 2,2′-azobis(2-amidinopropane)-nitrate, 2,2′-azobisisobutane, 2,2′-azobisisobutylamide, 2,2′-azobisisobutane, 2,2′-azobisiobutyronitrile, methyl 2,2′-azobis-2-methylpropionate, 2,2′-dichloro-2,2′azobisbutane, 2,2′-azobis-2-methbutyronitrile, dimethyl 2,2′-azobisisobutylrate, 1,1′-azobis (sodium-methylbutyronitrile-3-sulfonate), 2-(4-methylphenylazo)-methylmalonodi-nitrile, 4-4′-azobis-4-cyanovalerate acid, 2,5-dihydroxymethylphenylazo-2-methylmalonodinitrile, (4-bromophenylazo)-2-allylmalonodinitrile, 2,2′-azobismethylvaleronitrile, dimethyl4,4′-azobis-4-cyanovalerate, 2,2′-azobis-2,4-dimethylvalcronitrile, 1,1′-azobiscyclohexanenitrile, 2,2′-azobis-2-propylbutyronitrile, 1,1′-azobis-1-chlorophenylethane, 1,1′-azobis-1-cyclohexanecarbonitrile, 1,1′-azobis-1-cycloheptanenitrile, 1,1′-azobis-1-phenylethane, 1,1′-azobiscumene, ethyl 4-nitrophenylazobenzylcyanoacetate, phenylazodiphenylmethane, phenylazotriphenylmethane, 4-nitrophenylazotriphenylmethane, 1′-azobis-2,2′-diphenylethane, poly(bisphenol A-4,4′-azobis-4-cyanopentano-ate), and poly(tetraethylene glycol-2,2′-azobisisobutyrate); and 1,4-bis(pentaethylene)-2-tetrazene, 1,4-dimethyoxycarbonyl-1,4-diphenyl-1-2-terazene; and mixture thereof.

Preferred free radical initiators include, for example, ammonium persulfate, hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, sodium persulfate, potassium persulfate, diisopropyl peroxycarbonate, etc. Most preferred are sodium, potassium, and ammonium persulfate salts.

Based on total weight of the monomers to be polymerized, the initiator may generally be present in an amount of about 0.1% to about 5%, preferably about 0.4% to about 4%, more preferably about 0.5% to about 3%, although it may be present in greater or lesser amounts.

### Coagulation

Following polymerization, the latex may be coagulated to isolate the bimodal polymer for characterization. Coagulating agents, including multivalent salts, such as aluminum sulfate, or acids, such as hydrochloric acid, will coagulate the latex. For example, the coagulating agent may be stirred with the finished latex (by hand, if necessary, due to the increasing viscosity of the mixture) to complete coagulation. Appropriate coagulation temperatures are about 20 to 50° C. Subsequently, isolation of the solid bimodal polymer may be accomplished by centrifugation, several water washes, and optionally filtration and vacuum drying.

### Analysis Test Methods

The polymer may be characterized by standard procedures used to analyze toner resins, including glass transition temperature, melt index (melt flow), flow test, acid number, and molecular weight. For example, glass transition temperature (T_{g}) may be measured using Differential Scanning calorimetry using a Model Q10 calorimeter obtained from TA Instruments (New Castle, Del.). Typical conditions include the use of an indium standard and a heating rate of 10° C./minute (second heat).

Melt index or melt flow according to ASTM Standard 1238 may be measured using a Tinius-Olsen (Willow Grove, Pa.) Extrusion Plastograph Model 993a. Typical conditions include a load of 2.16 Kg and a temperature of 125° C. or 150° C.

In a flowtest, two parameters are determined: Tm (T_{1/2}, melting point by the ½ method), and Ti (Tfb, beginning flow by the ½ method). Flowtest may be measured using a Shimadzu Capillary Rheometer, Model CFT 500D (Shimadzu Instrument Co., Columbia, Md.). Typical conditions include a load of 20 Kg and a heating rate of 6° C./min.

Acid Number is determined as described in ASTM D-1639-83.

Finally, molecular weight of the polymers is determined using gel permeation chromatography. A typical apparatus includes a Waters (Waters Corp., Milford, Mass.) 600E Systems Controller, 610E Fluid Unit, 410 Differential Refractometer, and 717 Plus Auto Sampler using as columns Waters Styragel Cluster containing Styragel HR1 and Styragel HMW6E and a column temperature of 40° C. Molecular weights are determined using a mixture of polystyrene standards having molecular weights from 500 to 8 MM Daltons.

### Polymer Properties

The bimodal polymer composition contains distinct low and high molecular weight portions. The high molecular weight component may be linear, branched, or cross-linked. A THF soluble portion of the bimodal composition preferably has a number average molecular weight (Mn) as measured by gel permeation chromatography of about 6.5×10³ to 75×10³, a weight average molecular weight (Mw) of about 35×10³ to 1,000×10³ and a polydispersity (Mw/Mn) of about 1.5 to 60.

A THF soluble portion of the high molecular weight component preferably has a number average molecular weight (Mn) as measured by gel permeation chromatography of about 100×10³ to 1500×10³, a weight average molecular weight (Mw) of about 290×10³ to 1800×10³, and a polydispersity (Mw/Mn) of about 1.2 to 3.

Preferred properties of the bimodal polymers include Tg from about 52° to about 62° C., acid number of about 1 to about 25 mg KOH/g polymer, Tm of about 106° to about 140° C., and Ti of about 88 to about 105° C.

Embodiments of the invention will now be described in conjunction with the following, non-limiting examples.

### EXAMPLE 1

### Synthesis of Low Molecular Weight Polymer (LMWP)

A mixture of di-butyl-peroxide (0.5 parts) in styrene (90 parts) and methacrylic acid (10 parts) was dissolved in xylene to form a solution having a 70:30 monomer:solvent ratio. The solution was continuously fed to a reactor maintained at 190° C. and a pressure of 6 kg/cm². The discharge port was maintained at 100° C. with a discharge rate of 750 cc/hr. The resulting polymer was isolated from solution by first distilling under nitrogen at atmospheric pressure to a pot temperature of 190° C. followed by vacuum distillation at 190-200° C. at <1 mm Hg for 1.5 hours.

The LMWP was analyzed as described above and the observed properties tabulated in Table 1.

### EXAMPLE 2

### Preparation of Bimodal Styrene Acrylate Latex

This example describes the preparation of a latex containing 20% of the low molecular weight polymer (LMWP).

A LMWP solution was prepared by charging a 1 liter blending flask equipped with a paddle stirrer with 176.2 g styrene, 57.8 g n-butyl acrylate, 6.0 g methacrylic acid, 0.72 g divinyl benzene, and 0.24 g of 2-ethylhexylthioglycolate. The LMWP (60.0 g) described in Example 1 was added portion-wise with stirring at room temperature. The mixture was stirred for 1 hour at 150 rpm or until all of the polymer was dissolved in the monomers.

A solution of 3.0 g of sodium C₁₂₋₁₆ alkyl benzene sulfonate (Calsoft F-90, Pilot Chemical Co.) and 6.7 g of ethoxylated phosphate ester (45% active, Dextrol OC-180, Ashland Chemical Co.) in 300 g deionized water was prepared in a blending flask equipped with an IKA Labortechnik rotor-stator mixer fitted with a TP45G generator. The aqueous surfactant phase was blended for 1 minute at 200 rpm, then at 5,000 rpm for 15 minutes, and finished at 10,000 rpm for 5 minutes. The high shear caused a temperature increase which was not allowed to exceed 50° C. The emulsion was degassed with a nitrogen sparge for 10 minutes.

A 1 liter polymerization reactor equipped with a paddle stirrer, heat controller/mantle, condenser, nitrogen inlet/outlet, and condenser was charged with 3.0 g of sodium C₁₂₋₁₆ alkyl benzene sulfonate, 6.7 g of the ethoxylated phosphate ester, and 280 g of deionized water. This aqueous phase was stirred and degassed by sparging with nitrogen as the temperature was increased to 75° C. Subsequently, 5% (30 g) of the LMWP/monomer emulsion was added with stirring, followed by the addition of the initiator solution of 2.4 g potassium persulfate in 20 g water. The reactants were allowed to polymerize for 15 minutes at 75° C. to form the seed polymer, after which time the remainder of the LMWP/monomer emulsion was added over a 3 hour period. The mixture was then stirred for 2 hours at 75° C.

No coagulum was observed during the polymerization. The latex had a shelf life in excess of 60 days without the precipitation of solids.

The latex was coagulated in order to characterize the polymer. Aluminum sulfate hydrate (3.0 g) was added to 200 g of latex and the mixture stirred at room temperature for 10 minutes. The coagulated mix was heated slowly with stirring to 70° C.; then cooled to room temperature and centrifuged at 3000 rpm for 10 minutes. The solid polymer was separated from the aqueous layer by decanting off the water. The polymer was washed three times with water using the same procedure, filtered from the final washing step, and then dried in a vacuum oven maintained at 50° C./30 mm Hg for 8 hours.

The bimodal polymer made under these conditions exhibited the properties shown in Table 1.

### EXAMPLE 3

This example describes the preparation of a latex containing 40% of the low molecular weight polymer. The same process described in Example 2 was followed with the exception of the amounts of materials used.

A LMWP solution was prepared by charging a 1 liter blending flask equipped with a paddle stirrer with 132.1 g styrene, 43.4 g n-butyl acrylate, 4.5 g methacrylic acid, and 0.045 g of 2-ethylhexylthioglycolate. The LMWP (120 g) described in Example 1 was added portion-wise with stirring at room temperature. The mixture was stirred for 1 hour at 150 rpm or until the entire polymer was dissolved in the monomers.

A solution of 9.0 g of sodium C₁₂₋₁₆ alkyl benzene sulfonate (Calsoft F-90, Pilot Chemical Co.) and 20.1 g of ethoxylated phosphate ester (45% active, Dextrol OC-180, Ashland Chemical Co.) in 300 g deionized water was prepared in a blending flask equipped with an IKA Labortechnik rotor-stator mixer fitted with a TP45G generator. The aqueous surfactant phase was blended for 1 minute at 200 rpm, then at 5,000 rpm for 15 minutes, and finished at 10,000 rpm for 5 minutes. The high shear caused a temperature increase which was not allowed to exceed 50° C. The emulsion was degassed with a nitrogen sparge for 10 minutes.

A 1 liter polymerization reactor equipped with a paddle stirrer, heat controller/mantle, condenser, nitrogen inlet/outlet, and condenser was charged with 9.0 g of sodium C12-16 alkyl benzene sulfonate, 20.1 g of the ethoxylated phosphate ester, and 280 g of deionized water. This aqueous phase was stirred and degassed by sparging with nitrogen as the temperature was increased to 75° C. Subsequently, 5% (30 g) of the LMWP/monomer emulsion was added with stirring followed by the addition of the initiator solution of 2.7 g potassium persulfate in 20 g water. The reactants were allowed to polymerize for 15 minutes at 75° C. to form the seed polymer, after which time the remainder of the LMWP/monomer emulsion was added over a 3 hour period. The mixture was then stirred for 2 hours at 75° C.

No coagulum was observed during the polymerization. The latex had a shelf life in excess of 60 days without the precipitation of solids.

The latex was coagulated in order to characterize the polymer. Aluminum sulfate hydrate (3.0 g) was added to 200 g of latex and the mixture stirred at room temperature for 10 minutes. The coagulated mix was heated slowly with stirring to 70° C.; then cooled to room temperature and centrifuged at 3,000 rpm for 10 minutes. The solid polymer was separated from the aqueous layer by decanting off the water. The polymer was washed three times with water using the same procedure, filtered from the final washing step, and dried in a vacuum oven maintained at 50° C./30 mm Hg for 8 hours.

The bimodal polymer made under these conditions exhibited the properties shown in Table 1.

TABLE 1

| | | | | | Acid Number | | | |
|---|---|---|---|---|---|---|---|---|
| | Tg | Melt Index | Tm | Ti | (mg KOH/ | Mw × | | |
| | (° C.) | (125° C./2.16 Kg) | (° C.) | (° C.) | g polymer | 10⁴ | Mn × 10⁴ | Mw/Mn |
| Ex. 1 | 58.4 | 9.3 g/10 min | 106.6 | 88 | 7.8 | | 0.4 | |
| | | (110° C.) | | | | | | |
| Ex. 2 | 56.2 | <1 g/10 min | 130 | 96.4 | 24.8 | 56.1 | 1.99 | 28.1 |
| | | (110° C.) | | | | | | |
| Ex. 3 | 52.8 | 6.1 g/10 min | 116.1 | 89.5 | 23.7 | 3.78 | 0.69 | 5.5 |

### EXAMPLE 4

### Comparative

This example describes the preparation of a latex containing 40% of the low molecular weight polymer. The same process described in Example 3 was followed with the exception of the total surfactant charge being 2% in water.

A LMWP solution was prepared by charging a 1 liter blending flask equipped with a paddle stirrer with 132.1 g styrene, 43.4 g n-butyl acrylate, 4.5 g methacrylic acid, and 0.18 g of 2-ethylhexylthioglycolate. The LMWP (120 g) described in Example 1 was added portion-wise with stirring at room temperature. The mixture was stirred for 1 hour at 150 rpm or until the entire polymer was dissolved in the monomers.

A solution of 3.0 g of sodium C₁₂₋₁₆ alkyl benzene sulfonate (Calsoft F-90, Pilot Chemical Co.) and 6.6 g of ethoxylated phosphate ester (45% active, Dextrol OC-180, Ashland Chemical Co.) in 300 g deionized water was prepared in a blending flask equipped with an IKA Labortechnik rotor-stator mixer fitted with a TP45G generator. The aqueous surfactant phase was blended for 1 minute at 200 rpm, then at 5,000 rpm for 15 minutes, and finished at 10,000 rpm for 5 minutes. The high shear caused a temperature increase which was not allowed to exceed 50° C. The emulsion was degassed with a nitrogen sparge for 10 minutes.

A 1 liter polymerization reactor equipped with a paddle stirrer, heat controller/mantle, condenser, nitrogen inlet/outlet, and condenser was charged with 3.0 g of sodium C₁₂₋₁₆ alkyl benzene sulfonate, 6.6 g of the ethoxylated phosphate ester, and 280 g of deionized water. This aqueous phase was stirred and degassed by sparging with nitrogen as the temperature was increased to 75° C. Subsequently, 5% (30 g) of the LMWP/monomer emulsion was added with stirring, followed by the addition of the initiator solution of 2.7 g potassium persulfate in 20 g water. The reactants were allowed to polymerize for 15 minutes at 75° C. to form the seed polymer, after which time the remainder of the LMWP/monomer emulsion was added over a 3 hour period. The mixture was then allowed to finish by stirring for 2 hours at 75° C.

Major amount of coagulum was observed during the polymerization, indicating an unstable emulsion. The latex was not coagulated for polymer characterization.

### EXAMPLE 5

### Comparative

This example describes the preparation of a latex containing 40% of the low molecular weight polymer. The same process described in Example 3 and 4 was followed with the exception of the total surfactant concentration being 4% in water.

A LMWP solution was prepared by charging a 1 liter blending flask equipped with a paddle stirrer with 132.1 g styrene, 43.4 g n-butyl acrylate, 4.5 g methacrylic acid, and 0.18 g of 2-ethylhexylthioglycolate. The LMWP (120 g) described in Example 1 was added portion-wise with stirring at room temperature. The mixture was stirred for 1 hour at 150 rpm or until the entire polymer was dissolved in the monomers.

A solution of 6.0 g of sodium C₁₂₋₁₆ alkyl benzene sulfonate (Calsoft F-90, Pilot Chemical Co,) and 13.2 g of ethoxylated phosphate ester (45% active, Dextrol OC-180, Ashland Chemical Co.) in 300 g deionized water was prepared in a blending flask equipped with an IKA Labortechnik rotor-stator mixer fitted with a TP45G generator. The aqueous surfactant phase was blended for 1 minute at 200 rpm, then at 5,000 rpm for 15 minutes, and finished at 10,000 rpm for 5 minutes. The high shear caused a temperature increase which was not allowed to exceed 50° C. The emulsion was degassed with a nitrogen sparge for 10 minutes.

A 1 liter polymerization reactor equipped with a paddle stirrer, heat controller/mantle, condenser, nitrogen inlet/outlet, and condenser was charged with 6.0 g of sodium C₁₂₋₁₆ alkyl benzene sulfonate, 13.2 g of the ethoxylated phosphate ester, and 280 g of deionized water. This aqueous phase was stirred and degassed by sparging with nitrogen as the temperature was increased to 75° C. Subsequently, 5% (30 g) of the LMWP/monomer emulsion was added with stirring followed by the addition of the initiator solution of 2.7 g potassium persulfate in 20g water. The reactants were allowed to polymerize for 15 minutes at 75° C. to form the seed polymer, after which time the remainder of the LMWP/monomer emulsion was added over a 3 hour period. The mixture was then stirred for 2 hours at 75° C.

Coagulum (28.7% based on the LMWP/monomer charge) was observed during the polymerization, indicating an unstable emulsion. The latex was not coagulated for polymer characterization.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A process for producing a bimodal molecular weight styrene vinyl latex polymer composition comprising:
(a) preparing a low molecular weight styrene polymer by solution polymerization of at least one styrene monomer;
(b) preparing a solution of the low molecular weight styrene polymer in a mixture containing styrene and at least one vinyl monomer:
(c) emulsifying the solution in water to form an emulsion; and
(d) polymerizing the low molecular weight styrene polymer and mixture containing styrene and at least one vinyl monomer using emulsion polymerization to form a bimodal molecular weight latex composition.

2. The process according to claim 1, wherein the solution polymerization is performed in an aromatic solvent via free radical initiated polymerization.

3. The process according to claim 2, wherein the aromatic solvent is selected from the group consisting of xylene, toluene, and ethyl benzene.

4. The method according to claim 1, wherein the low molecular weight styrene polymer comprises a styrene copolymer.

5. The process according to claim 4, wherein the styrene copolymer further comprises at least one of acrylates and alkyl methacrylates as comonomers.

6. The process according to claim 4, wherein the styrene copolymer further comprises at least one acidic vinyl comonomer.

7. The process according to claim 1, wherein the solution in step (b) comprises about 1 to 50% low molecular weight styrene polymer.

8. The process according to claim 7, wherein the solution in step (b) comprises about 20 to 30% low molecular weight styrene polymer.

9. The process according to claim 2, wherein the free radical polymerization is performed using a polymerization initiator selected from the group consisting of a perester, a hydroperoxide, a dialkyl peroxide, a ketone peroxide, a diacyl peroxide, a percarbonate, and an azobis derivative.

10. The process according to claim 9, wherein the initiator is present in an amount of about 0.05 to 5.0 parts by weight per 100 parts by weight of the at least one styrene monomer.

11. The process according to claim 1, wherein the low molecular weight polymer has a number average molecular weight (Mn) as measured by gel permeation chromatography of about 1,000 to 10,000 Daltons.

12. The process according to claim 1, wherein the low molecular weight polymer has a number average molecular weight (Mn) as measured by gel permeation chromatography of about 2,000 to 5,000 Daltons.

13. The process according to claim 1, wherein the solution in step (b) further comprises a branching agent.

14. The process according to claim 13, wherein the branching agent comprises a multifunctional vinyl compound.

15. The process according to claim 1, wherein the solution in step (b) further comprises a chain modifier.

16. The process according to claim 15, wherein the chain modifier comprises a thiol.

17. The process according to claim 1, wherein a THF soluble portion of the bimodal styrene vinyl polymer has a number average molecular weight as measured by gel permeation chromatography of about 6.5×10³ to 75×10³ Daltons, a weight average molecular weight of about 35×10³ to 1,000×10³ and a polydispersity of about 1.5 to 60.

18. The process according to claim 1, wherein the bimodal molecular weight styrene vinyl polymer comprises a high molecular weight component and a low molecular weight component, and wherein a THF soluble portion of the high molecular weight component has a number average molecular weight as measured by gel permeation chromatography of about 100×10³ to 1500×10³ Daltons, a weight average molecular weight of about 290×10³ to 1800×10³, and a polydispersity of about 1.2 to 3.

19. The process according to claim 1, wherein step (c) comprises forming an emulsion having a ratio of solution to water of about 1:4 to 3:2.

20. The process according to claim 1, wherein step (c) comprises forming the emulsion using a water soluble surfactant selected from the group consisting of an anionic surfactant, a nonionic surfactant, a cationic surfactant, and mixtures thereof.

21. The process according to claim 1, wherein the polymerization in step (d) is performed using a free radical initiator.

22. The process according to claim 21, wherein the free radical initiator comprises a sodium, potassium, or ammonium persulfate salt.

23. The process according to claim 1, wherein the polymerization in step (d) is performed at about 50 to 90° C.

24. The process according to claim 1, wherein the mixture containing styrene and at least one vinyl monomer comprises at least one selected from the group consisting of an alkyl acrylate and an alkyl methacrylate.

25. The process according to claim 24, wherein the mixture further comprises at least one vinyl acidic monomer selected from the group consisting of acrylic acid and methacrylic acid.

26. A bimodal molecular weight styrene vinyl latex polymer composition prepared by a process comprising:
(a) preparing a low molecular weight styrene polymer by solution polymerization of at least one styrene monomer;
(b) preparing a solution of the low molecular weight styrene polymer in a mixture containing styrene and at least one vinyl monomer;
(c) emulsifying the solution in water to form an emulsion; and
(d) polymerizing the low molecular weight styrene polymer and mixture containing styrene and at least one vinyl monomer using emulsion polymerization to form a bimodal molecular weight latex composition.

27. A process for producing a chemically produced toner by emulsion aggregation comprising emulsion polymerizing a bimodal styrene vinyl latex polymer composition prepared by a process comprising:
(a) preparing a low molecular weight styrene polymer by solution polymerization of at least one styrene monomer;
(b) preparing a solution of the low molecular weight styrene polymer in a mixture containing styrene and at least one vinyl monomer;
(c) emulsifying the solution in water to form an emulsion; and
(d) polymerizing the low molecular weight styrene polymer and mixture containing styrene and at least one vinyl monomer using emulsion polymerization to form a bimodal molecular weight latex composition.
